(19) United States
(12) Patent Application Publication
(10) Pub. No.: US 2012/0100950 A1
(43) Pub. Date: Apr. 26, 2012

(54) AUXILIARY REAR PLANETARY LUBRICATION IMPROVEMENT FOR 700R4/4L60E

(76) Inventor: Luther Preston Deans, Clayton, NC (US)

(21) Appl. No.: 13/280,255

(22) Filed: Oct. 24, 2011

Related U.S. Application Data
(60) Provisional application No. 61/406,004, filed on Oct. 22, 2010.

(51) Int. Cl. F16H 57/04; B23P 23/00

(52) U.S. Cl. 475/159; 29/401.1

(57) ABSTRACT

The present invention relates to automatic transmissions. In particular, the invention relates to a novel method and device applied to the GM 700r4/4l60e transmission which is known to have rear planetary gears lubrication failure at 60,000 miles. The planetary gear pins suffer inadequate lube due to lube oil supplied from output shaft is centrifugally thrown off the rotating planetary. The pins set at right angles to the flow of oil making lubrication of the pins inadequate. The method of the present invention improves the lubrication by installing an auxiliary oil line which connects the OEM oil line at the back of transmission case, runs through the case and stops at the top of spring retainer, providing horizontal oil spray. Pins are available with oiling holes, if used with horizontally pressurized oil sprayed thru holes placed in the planetary hub then into the pins failure would not occur.

### REFERENCE TO RELATED APPLICATIONS

This patent application claims the benefit of U.S. Provisional Application No. 61/406,004 filed on Oct. 22, 2010, the disclosure of which is incorporated herein by reference in its entirety.

### BACKGROUND OF THE INVENTION

1. Field of the Invention

The present invention relates generally to automatic transmissions, and more specifically to auxiliary rear planetary lubrication improvement for 700r4/4l60e.

2. Description of Related Art

Since GM first introduced the four speed automatic overdrive in the Corvette in 1982, the 700R4/4L60E family had many failures. The factory made improvements every year along with the aftermarket transmission improvement industry as disclosed in U.S. Pat. Nos. 5,503,601; 7,195,578; 7,527,577; 7,608,010; and U.S. PreGrant Pub. Nos. 2006/0122027; 2008/0167157; 2009/0258753; 2010/0210408, and 2011/0211785. It is understood that any reference hereinafter to the 4L60E or 700R4 transmissions includes the 700R4/4L60E family.

One of a few remaining problems is the rear planetary gears failure. The rear planetary gear assembly is comprised of a sun gear in the center, a ring gear, and a plurality of planet gears supported by a plurality of gear pins connected to the planetary carrier. The lube supply circuit feeding the rear planetary starts to fail at 60,000 miles. The invention disclosed in U.S. Pat. No. 7,608,010 also relates to the improved performance of the rear planetary gear but the invention relates to a new and improved thrust bearing assembly which addresses to solving a different cause of rear planetary failure.

The causes of rear planetary failure could be lubrication related. In 700R4/4L60E Original Equipment Manufacturer (OEM) transmission design, the rear planetary gear assembly receives lube oil from the output shaft. When the oil enters the center of the planetary carrier, due to rotation, the oil is centrifugally thrown vertically outward and thus lubricates the sun gear, planetary carrier gears, and ring gear. The carrier planetary gear also has horizontal placed pins supporting the planet gears. The planetary gear pins suffer inadequate lube due to lube oil supplied from output shaft is centrifugally thrown off the rotating planetary. The pins set at right angles to the flow of oil making lubrication of the pins inadequate. There is no invention in the prior art that addresses to solving this problem.

Therefore, there exists a need to have a method and/or a device that provides rear planetary gear adequate lubrication, especially for the gear pins.

### SUMMARY OF THE INVENTION

One object of the invention is to provide a method and/or a device that provides adequate lubrication to the rear planetary gears, especially the gear pins.

Another object of the invention is to provide a method and/or device that provide an auxiliary oil line to spray lubrication oil horizontally into the carrier housing pins (gear pins).

There are at least two methods of accomplishing this improvement. The preferred method is the easiest to install a tube between the rear output shaft case and rear output shaft bushing. This requires cutting a small groove between the case and the bushing.

In one embodiment, an auxiliary oil line (e.g. a small copper tube) is tapped into the OEM lubrication (oil line) circuit, and runs into the transmission case, the hole on the bushing, and stops at the top of the spring retainer just next to the hole on the planetary ring gear hub and is parallel to the gear pins that hold planet gears to the planetary carrier housing. Thus, the auxiliary oil line can provide horizontally pressured oil spray through holes placed in the planetary hub into pins.

In another embodiment, an oil line (e.g. a small copper tube) attached to the OEM lubrication (oil line) circuit at the back of the case is routed into the low reverse piston section through one spring of the spring retainer and rests flush with the top of the spring retainer. The center of the spring retainer spring will align with the planetary gear pins oiling orifice. Thus, the auxiliary oil line can provide horizontally pressured oil spray through holes placed in the planetary hub into pins.

Driving in 4^{th} gear (overdrive) at highway speeds or towing greatly increases the torque load on the pins making auxiliary pin oiling mandatory to prevent planetary failure. Pins are available with oiling holes, if used with horizontally pressurized oil sprayed through holes placed in the planetary hub then into the pins failure would not occur.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 shows a rear view of the transmission case with a small tube (oil line) tapped into the lubrication circuit and runs into the case.

FIG. 2 shows a front view of a transmission case with a small tube (oil line) running out of the case and stopping at the spring retainer.

FIG. 3 shows copper oil line running through window slot cut in ring gear hub.

FIG. 4 shows planetary carrier gears with four planet gears and four pin oiling orifices.

FIG. 5 shows a side view of partially exploded rear planetary gears assembly with output shaft.

FIG. 6 shows a blow-up diagram illustrating why an auxiliary oil line can improve the lubrication of gear pins in the rear planetary gears.

FIG. 7 shows a rear view of the transmission case with an auxiliary oil line used with the method attached to the lubrication circuit and inserted into the low reverse piston (not shown) through the location (indicated by a small arrow) of one spring of the spring retainer (not shown).

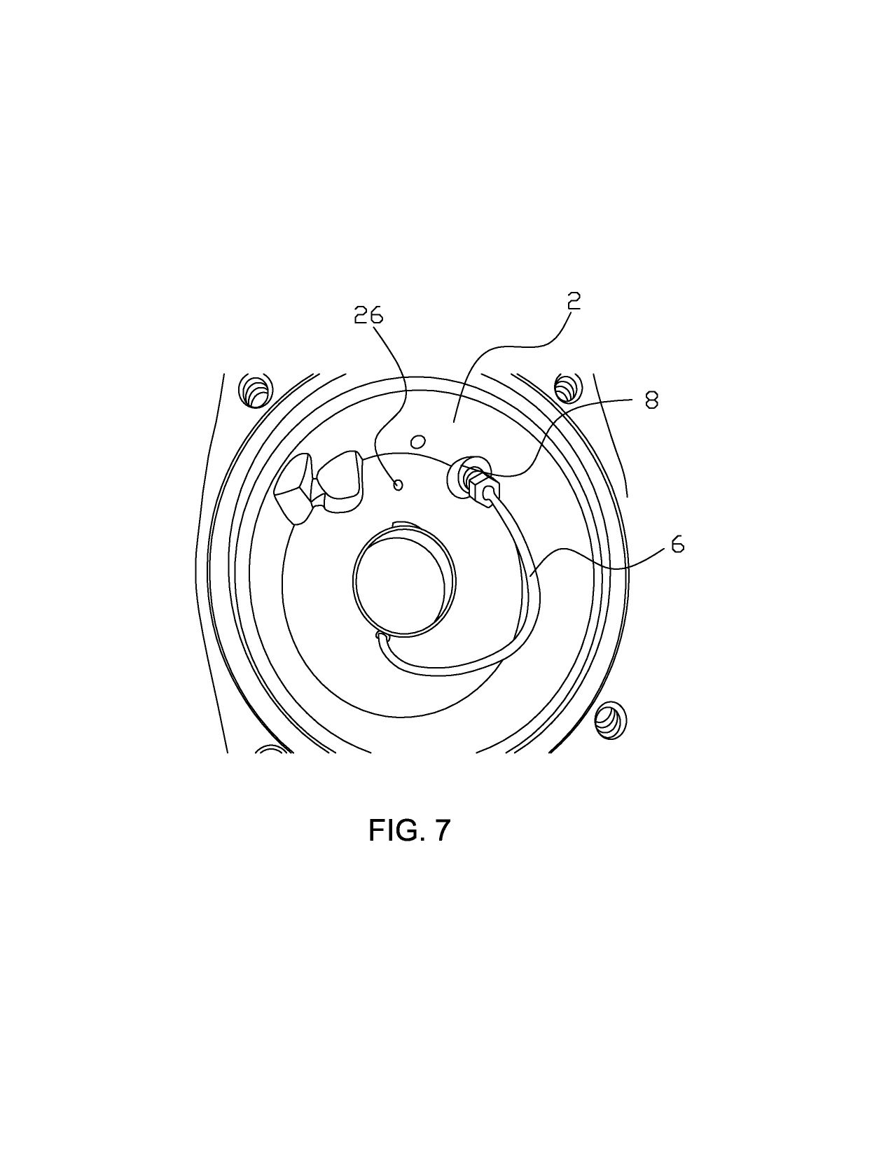

FIG. 8 shows a front view of a transmission case with an auxiliary oil line used with the method running out of the case through one cut hole on the case.

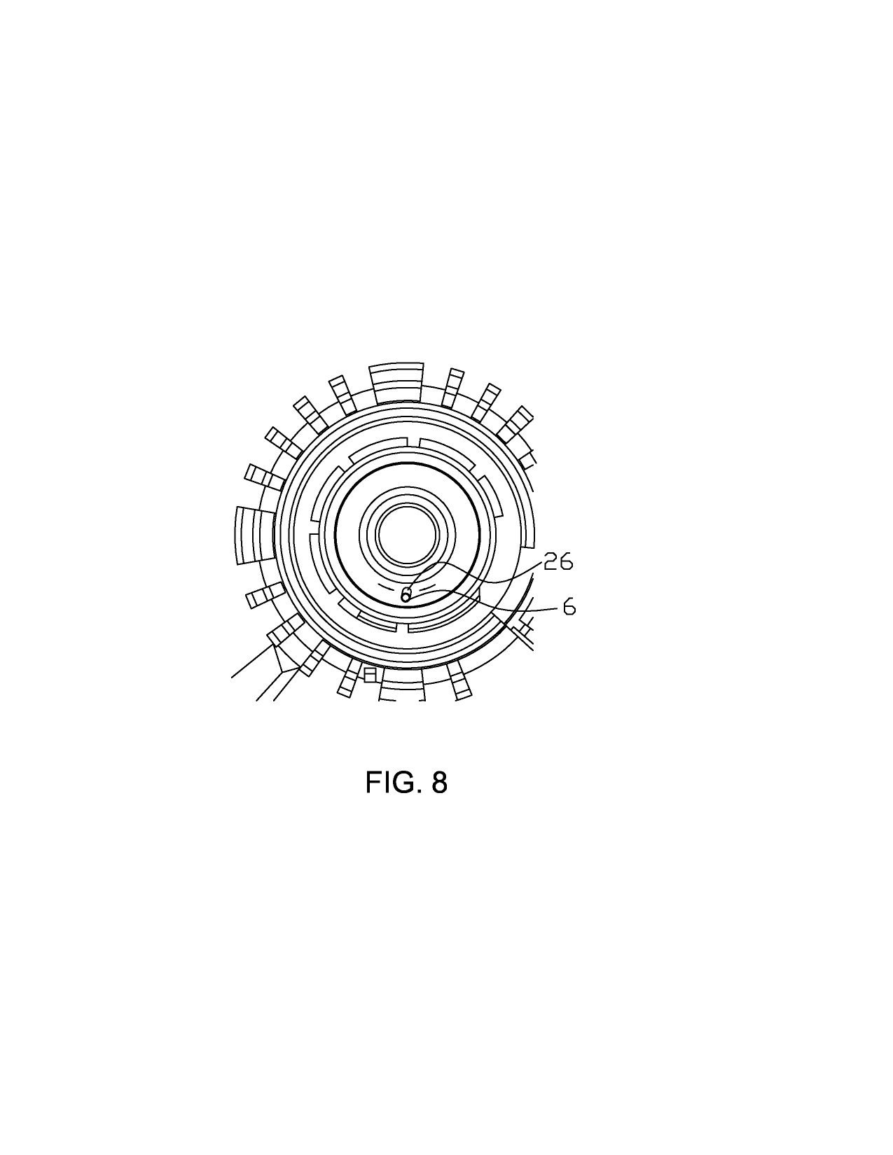

FIG. 9 shows a front view of a spring retainer with an auxiliary oil line used with the method running through the case and low reverse piston and out of one spring of the spring retainer.

### DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

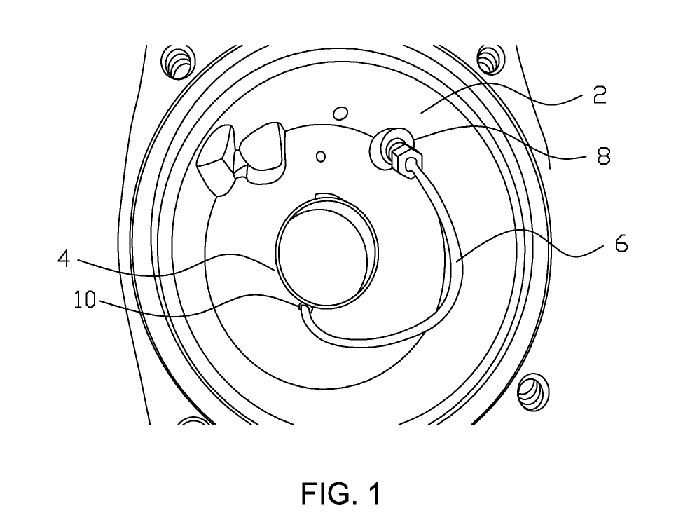

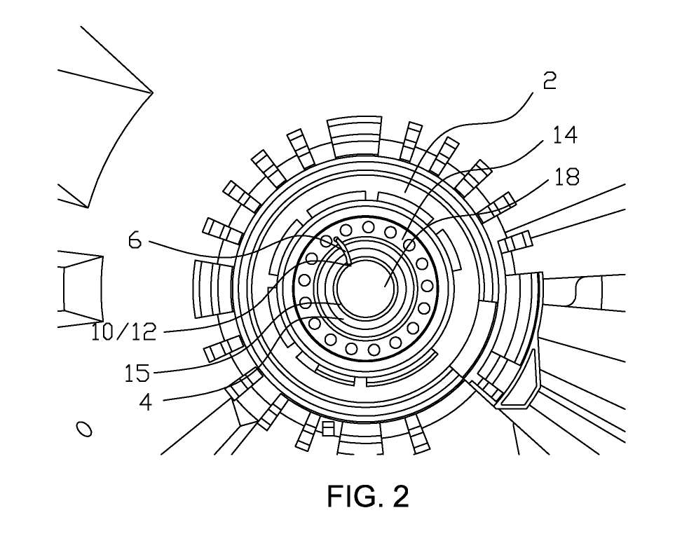

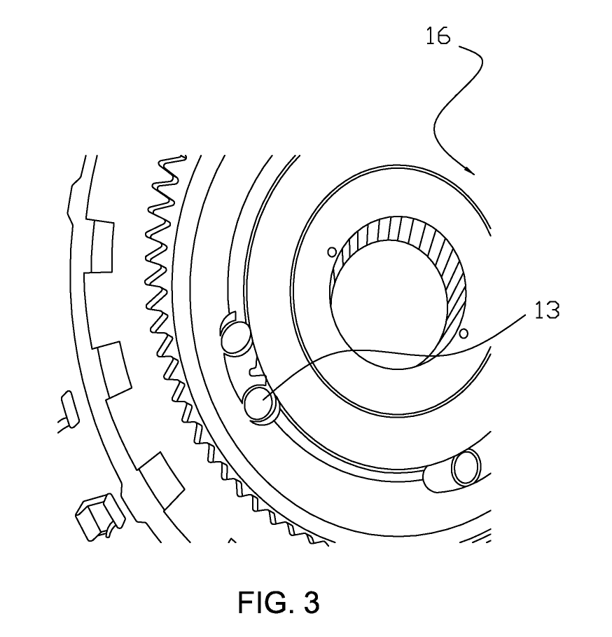

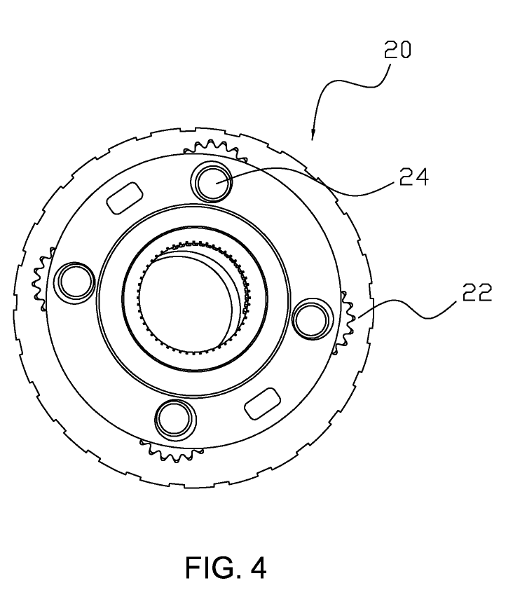

There are two methods for improving the rear planetary gear assembly lubrication especially for planet gear pins. Referring to FIG. 1 to FIG. 6 there are disclosed steps of a preferred method. The preferred method comprises drilling a passageway (hole) 10 between the case 2 and the rear output shaft bushing 4, then installing a small tube (e.g. a copper oil line) 6 which starts from the OEM lubrication circuit 8 at the back of the case 2 (shown in FIG. 1) through the bushing hole 10 and a notch cut 12 next to the center of spring retainer housing 15 and stops at the top of the spring retainer 14 as shown in FIG. 2. FIG. 3 shows window slot cut 13 in ring gear hub 16 where the copper oil line 6 should be visible through the window slot cut 13 once the ring gear hub 16 was placed on the spring retainer 14. FIG. 4 shows a planetary carrier gear 20 with four planet gears 22 and four pin oiling orifices 24.

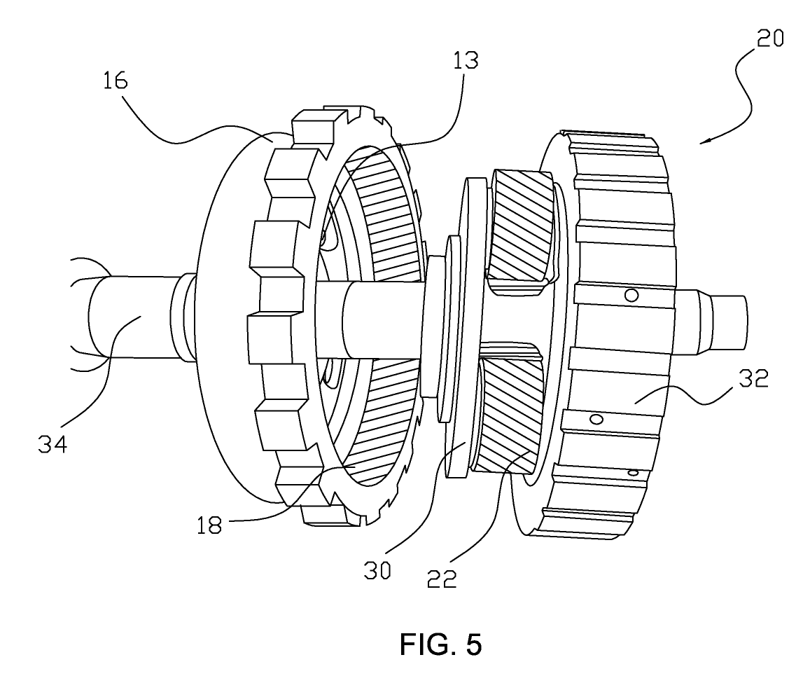

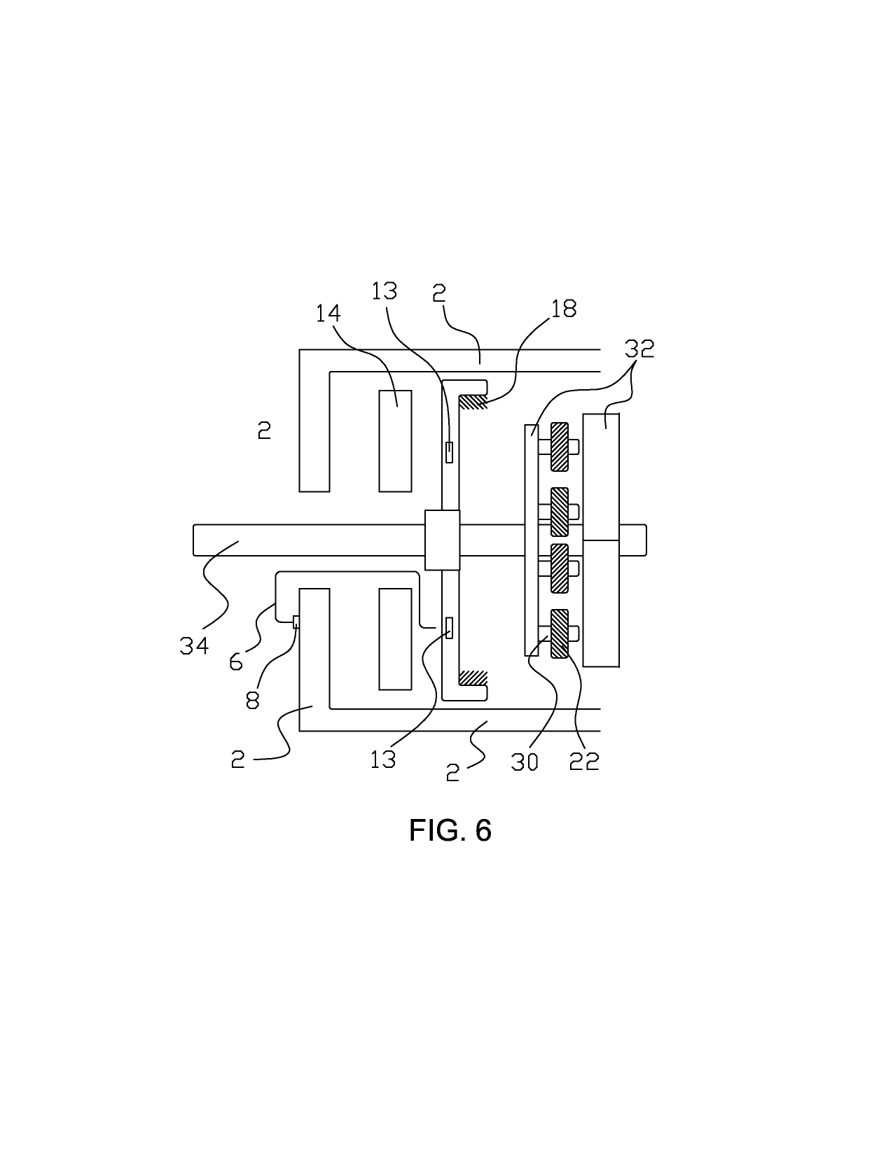

To easily comprehend the positional relationship of the auxiliary oil line 6 relative to the gear pins 30, a partially exploded side view shown in FIG. 5 of a rear planetary gears 20 having ring gear 18 inside ring gear hub 16 (with holes 13) and planet gears 22 held onto the planetary carrier 20 by planet gear pins 30 as well as output shaft 34. Although the transmission case 2, the auxiliary oil line 6, or the retainer spring housing 15 is not shown in this figure, the arrow indicates where the auxiliary oil line 6 coming from. After the ring gear 18, ring gear hub 16, and planetary carrier gears 20 are placed into the case 2, the auxiliary oil line 6 will be close to the hole 13 on the planetary ring gear hub 16 and is parallel to the gear pins 30 that hold planet gears 22 to the planetary carrier housing 32 as illustrated in FIG. 6.

FIG. 6 further elaborates why an auxiliary oil line 6 can help improve lubrication of gear pins 30 in rear planetary gears by showing the position of the auxiliary oil line 6 and the components of the rear planetary gears installed in the transmission case 2 in a diagram. It is clearly seen that the auxiliary oil line 6 coming from the back of transmission case 2 after routing (running) through the transmission case 2 and spring retainer 14 stops at the top of spring retainer 14 just next to the hole 13 on the planetary ring gear hub 16 and is parallel to the gear pins 30 that hold planet gears 22 to the planetary carrier housing 32. Thus, the auxiliary oil line 6 can provide horizontally pressured oil spray through holes 13 placed in the planetary hub 16 into the gear pins 30.

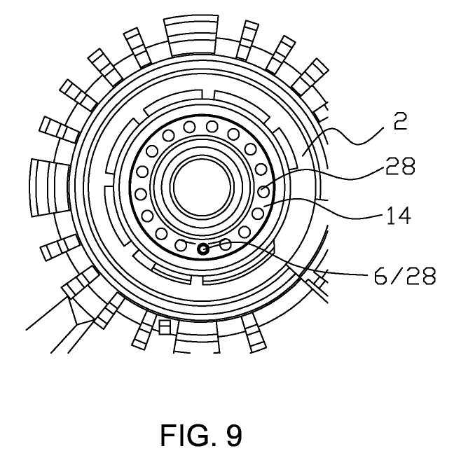

Referring to FIG. to FIG. 9 there is disclosed a second method. The second method comprises routing the oil line with a small tube 6 starting from the OEM lube circuit 8 through the hole 26 (indicated by blue ink arrow) on the case housing 2 then into the low reverse piston (not shown) and then into one of the retainer springs 28, terminating the oil line 6 flush with the top of the spring retainer 14 as shown in FIG. 10. Similar to FIG. 6, once the ring gear 18 is placed into the case 2 and planetary carrier gears 20 is installed next to the ring gear 18, the center of the spring retainer spring 28 will align with the planetary gear pins oiling orifice 24; thus, the auxiliary oil line 6 will align with the planetary gear pins oiling orifice 24 and thus provides horizontally pressured oil spray into the gear pins 30.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method of modifying a transmission to improve the rear planetary (especially gear pins) lubrication comprising: installing an auxiliary oil line to extend the OEM lubrication oil line circuit at the back of the transmission case.

2. The method of modifying a transmission to improve the rear planetary (especially gear pins) lubrication of claim 1 further comprises drilling a passageway (hole) between the transmission case and the rear output shaft bushing; and cutting a notch to the center of spring retainer housing.

3. The method of modifying a transmission to improve the rear planetary (especially gear pins) lubrication of claim 2 further comprises inserting the auxiliary oil line through the hole on the bushing and stopping the auxiliary oil line at top of the spring retainer.

4. The method of modifying a transmission to improve the rear planetary (especially gear pins) lubrication of claim 3 wherein the gear pins having oiling holes.

5. The method of modifying a transmission to improve the rear planetary (especially gear pins) lubrication of claim 3 wherein the auxiliary oil line can provide horizontally pressured oil spray through holes placed in the planetary hub into gear pins.

6. The method of modifying a transmission to improve the rear planetary (especially gear pins) lubrication of claim 1 further comprises routing the auxiliary oil line through the case housing into the low reverse piston into one of the retainer housing springs and terminating the auxiliary oil line flush with the top of spring retainer.

7. The method of modifying a transmission to improve the rear planetary (especially gear pins) lubrication of claim 6 wherein the gear pins having oiling orifices and the center of the spring retainer spring aligns with the planetary gear pins oiling orifice.

8. A method of modifying a transmission to improve the rear planetary lubrication comprises drilling a passageway (hole) between the transmission case and the rear output shaft bushing; cutting a notch to the center of spring retainer housing; and installing an auxiliary oil line to extend the OEM lubrication oil line circuit; wherein the auxiliary oil line is tapped into the OEM oil line circuit and runs through the hole on the bushing and stops at the top of spring retainer; the gear pins having oiling holes; the auxiliary oil line can provide horizontally pressured oil spray through holes placed in the planetary hub into gear pins.

9. A transmission with an auxiliary rear planetary (especially gear pins) lubrication improvement comprises an auxiliary oil line extending from the OEM lubrication oil line circuit at the back of the transmission case to improve the planetary lubrication.

10. The transmission with an auxiliary rear planetary (especially gear pins) lubrication improvement of claim 9 wherein the auxiliary oil line extending from the OEM lubrication oil line circuit at the back of the transmission case is inserted through a hole on the rear output shaft bushing and a notch cut to the center of spring retainer housing and stops at the top of spring retainer.

11. The transmission with an auxiliary rear planetary lubrication improvement of claim 10 wherein the gear pins having oiling orifices, the auxiliary oil line can provide horizontally pressured oil spray through holes placed in the planetary hub into gear pins.

12. The transmission with an auxiliary rear planetary lubrication improvement of claim 9 wherein the auxiliary oil line extending from the OEM lubrication oil line circuit at the back of the transmission case is routing through the case housing into the low reverse piston into one of the retainer springs, and terminates flush with the top of the spring retainer.

13. The transmission with an auxiliary rear planetary lubrication improvement of claim 12 wherein the gear pins having oiling orifices and the center of the spring retainer spring aligns with the planetary gear pins oiling orifice.
